(19) United States
(12) Patent Application Publication
(10) Pub. No.: US 2009/0165075 A1
(43) Pub. Date: Jun. 25, 2009

(54) Landline Telephony Alternative for Service in a Satellite System or Other Conditional Access System

(75) Inventor: Scott Rhodes, Naperville, IL (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/959,559

(22) Filed: Dec. 19, 2007

(51) Int. Cl. H04N 7/16

(52) U.S. Cl. 725/153

(57) ABSTRACT

Conditional access for a service, such as a premium satellite service or other type of service, is provided using a non-landline telephone connection between a set top box and a service provider. An event requiring transmission of information to the service provider from a set top box is detected. A non-landline telephone connection between the set top box and the service provider is established. The information is sent to the service provider via the non-landline telephone connection. A service is received via the set top box in response to sending the information. The service is provided via a medium different than the non-landline connection.

### BACKGROUND

Current set top boxes (receivers) for use in a satellite television system require a connection to an active telephone landline in order to provide the customer with a method to order premium services, such as pay-per-view content, on-demand content, access to games, etc. Typical satellite television service is generally unidirectional. For example, television programming or other content is provided to the customer premises via satellite, but information is not transmitted from the customer premises via the satellite connection to the service provider. Thus, an active landline for a telephone system is connected to the satellite set top box to provide for bi-directional communication with the service provider. For example, a customer may order pay-per-view, and the order is sent to the service provider via an active landline telephone system.

An active landline telephone system typically includes a twisted-pair loop line at the customer premises. In many situations, the loopline is connected to a public-switched telephone network (PSTN) for providing conventional plain old telephone service (POTS). For example, customer premises equipment (CPE) such as telephones, facsimile machines, answering machines, satellite set top boxes, etc., are connected to loopline to send and/or receive calls. In other situations, a voice-over Internet Protocol (VOIP) service is used as the active landline telephone system. For VoIP, CPE such as telephones, satellite set top boxes, etc., are also connected to the loopline at the customer premises, but the landline telephone service is provided via an external IP network instead of the PSTN.

In growing numbers, consumers are choosing to cancel their landline telephone service and maintain their cellular telephone service as their sole means of telephony. Consumers not having an active landline telephone system but having satellite service must have another means for sending orders to the service provider.

Satellite service providers provide alternative means for the customer to order premium services, however, the alternative means for ordering are inconvenient and namely comprise a customer-dialed telephone call answered by a customer service representative or ordering a premium service via the Internet. By far, the easiest method for the customer to order new programming or services is while sitting in front of the television and making the necessary selection using the remote control. Today, if the customer possesses only a mobile telephone or otherwise does not have an active landline telephone service, this method of ordering is not available to them.

### BRIEF DESCRIPTION OF THE DRAWINGS

Various features of the embodiments described in the following detailed description can be more fully appreciated when considered with reference to the accompanying figures, wherein the same numbers refer to the same elements.

FIG. 1 illustrates a system, according to an embodiment;

FIG. 2 illustrates another system, according to an embodiment;

FIG. 3 illustrates a method, according to an embodiment; and

FIG. 4 illustrates a block diagram of a computing platform, according to an embodiment.

### DETAILED DESCRIPTION

For simplicity and illustrative purposes, the principles of the embodiments are described by referring mainly to examples thereof. In the following description, numerous specific details are set forth in order to provide a thorough understanding of the embodiments. It will be apparent however, to one of ordinary skill in the art, that the embodiments may be practiced without limitation to these specific details. In other instances, well known methods and structures have not been described in detail so as not to unnecessarily obscure the description of the embodiments.

For certain systems, conditional access to services is provided through verification performed by an active landline telephone system. These services, such as the satellite service described above, may need communication to the service provider via a telephony line to order a service. According to embodiments, instead of using an active landline telephone system to communicate with the service provider, communication is provided via a local area network (LAN) at the customer premises or is provided via a wireless connection to a customer's mobile phone. Thus, the embodiments provide a customer of a satellite television service that does not have a landline telephone readily available at the set top box with the same level of convenience already enjoyed by others with such a landline telephone. It would also allow satellite television service providers to be that much more “on par” with competing cable service providers (as cable does not require a telephone line connection, but instead is capable of transmitting the request for service via the cable network).

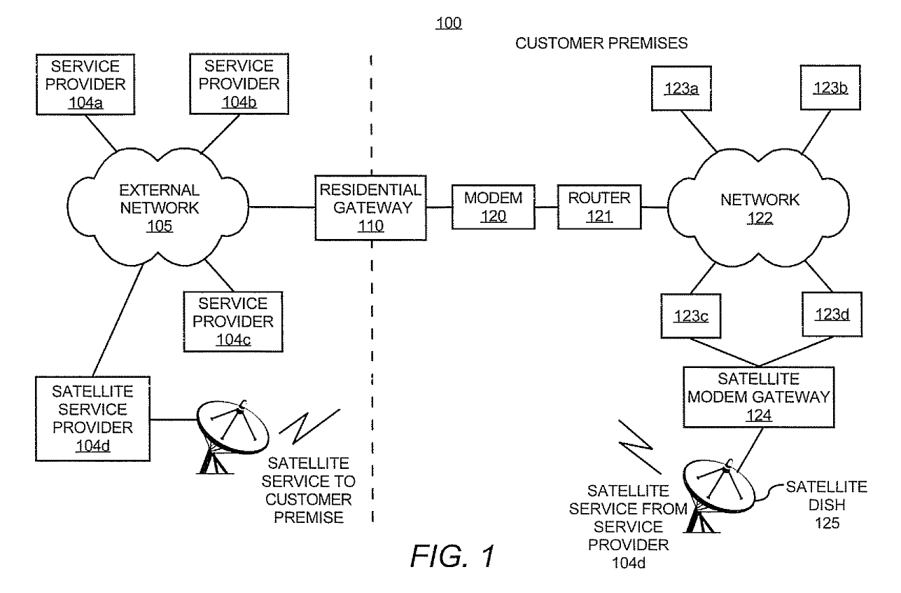

FIG. 1 illustrates a system 100 providing a conditional access service using a LAN at the customer premises, according to an embodiment. The system 100 includes a customer premises with CPE connected a network 122. The network 122 may include a wired or wireless LAN. A wireless LAN may use WiFi or other known protocols.

The CPE includes devices 123a-d, such as one or more set top boxes, computers, etc. The network 122 and the devices 123a-d may be connected to an external network 105 via a router 121, a modem 120 and a residential gateway 1 10. The router 121 may perform routing of packets in the network 122 and forwarding of packets to the network 105. The modem 120 provides access to digital signals modulated with an analog carrier. The residential gateway 110 is the gateway between the network 122 and the network 105. One or more of the modem 120, the residential gateway 110 and the router 121 may be provided as a single device or as separate standalone devices. The external network 105 may include an IP network, such as the Internet. The network 105 may include a cable network, such as a hybrid fiber coaxial (HFC) network. Service providers 104a-d may be connected to the CPE via the network 105 and the network 122. Examples of service providers include cable service providers, high-speed Internet service providers, etc.

One or more of the devices 123a-d may be devices receiving services via 33satellite. For example, the devices 123c and 123d are satellite set top boxes that receive satellite television service via the satellite gateway 124 and the satellite dish 125. The satellite gateway 124 may include a modem and other circuits as is known in the art for receiving the satellite television content and distributing the content to the set top boxes 123c and 123d. The satellite service provider is shown as 104d and provides the satellite television service to customer premises.

According to an embodiment, the satellite service provider 104d is also connected to the network 105 for communicating with the set top boxes 123c and 123d. For example, the set top boxes 123c and 123d include network interfaces for connecting to the network 122. The set top boxes 123c and 123d are configured to establish communication with the satellite service provider 104d via the network 122 and the network 105 in order to send requests for services, such as pay-per-view, video-on-demand, access to games, and so on. These requests are communicated via the network 122 and the network 105. The satellite service provider 104d may then provide the requested service, such as pay-per-view, video-on-demand, access to games, etc., to the set top boxes 123c and 123d via satellite.

Other requests and communications may also be sent from the set top boxes 123c and 123d to the satellite service provider 104d via the network 122 and the network 105. These requests may include requests for current account balance, bill-pay, or other account management activities.

Even if the customer premises includes an active landline telephone system, the user may still configure the set top boxes 123c and 123d to communicate with the service provider 104d via the network 122 and the network 105. For example, a user interface for the set top boxes 123c and 123d may allow the user to select the communication means, such as via a LAN or active telephone landline. Thus, the user can keep the telephone service open for its main function to place and receive phone calls.

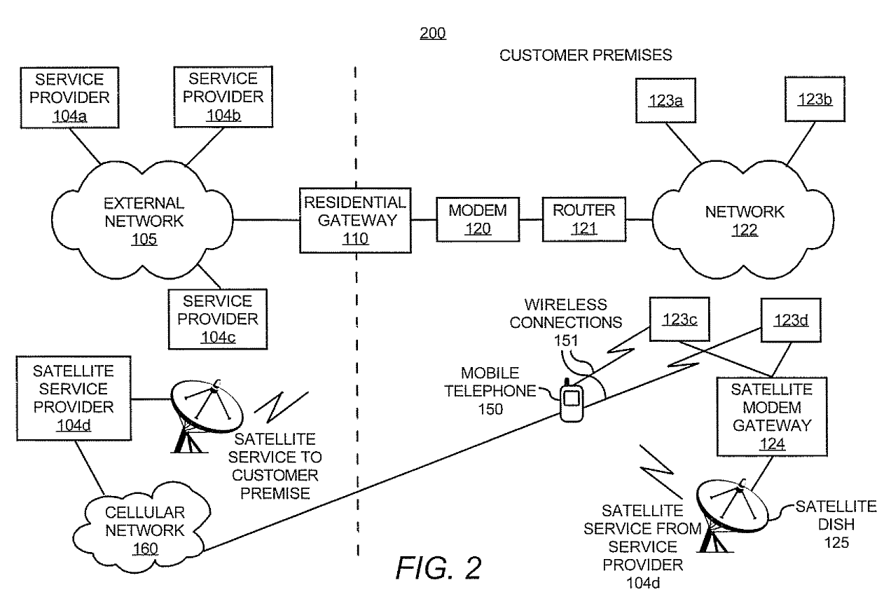

FIG. 2 illustrates another embodiment of a system 200 for providing an alternative means for communicating with the service provider. The system 200 is similar to the system 100, except the system 200 uses a cellular network 160 to communicate with the satellite service provider 104d instead of a LAN.

As shown in the system 200, the satellite set top boxes 123c and 123d are not connected to the network 122. Instead, the satellite set top boxes 123c and 123d are connected to a mobile telephone 150 via wireless connections 151, such as a Bluetooth connection. A wired connection, such as via a USB cable or other cable, may alternatively be used but is less convenient.

The mobile telephone 150 sends requests for premium services or other communications to the satellite service provider 104d via a cellular network 160. These requests are communicated via a cellular call, which is similar to sending requests via a telephone call made using an active landline telephone system if one were available and connected to the set top boxes 123c and 123d. The satellite service provider 104d may then provide the requested service, such as pay-per-view, video on demand, etc., to the set top boxes 123c and 123d via satellite.

The user may initially configure the set top boxes 123c and 123d to set up the wireless connections 151. For example, during an initial set up, the set top boxes 123c and 123d prompts the user via a user interface to establish a pairing with a Bluetooth device, such as the mobile telephone 150. Once the pairing is established, the set top box may be configured to automatically communicate with the mobile telephone 150 when it is within range to send/receive cellular calls via the mobile telephone 150 and send requests to the satellite service provider 104d via cellular calls.

In both systems 100 and 200, the set top boxes 123c and 123d may be configured to send information to the satellite service provider 104d via more than one means. For example, in the system 200, if the mobile telephone 150 is unavailable, the set top boxes may use a network connection (assuming the satellite service provider 104d is connected to the network 105 as shown in FIG. 1 and the set top boxes 123c and 123d can connect to the LAN 122 also shown in FIG. 1) or an active landline telephone system to send information to the satellite service provider 104d if those connections are available.

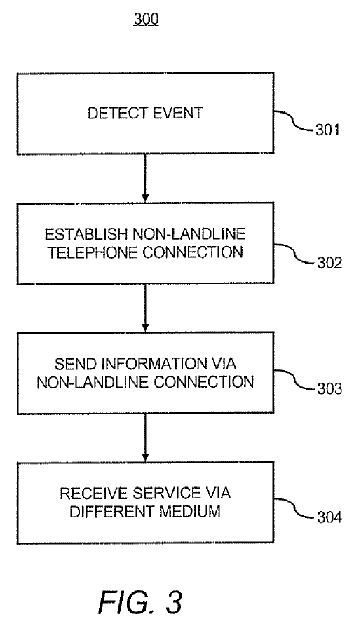

FIG. 3 illustrates a method 300 for providing conditional access for a service, according to an embodiment. The method 300 is described with respect to one or more of the systems described in FIGS. 1 and 2 by way of example and not limitation. The method may be practiced in other systems.

At step 301, an event requiring transmission of information to a service provider from a set top box is detected. For example, a user may request a premium service, such as pay-per-view, video-on-demand, access to games, etc., from the satellite service provider 104d. The request may include a request for account information or to perform account maintenance, such as bill pay. The set top box 123c receives the request via a user interface.

At step 302, a non-landline telephone connection between the set top box and the service provider is established. This may include establishing a LAN connection or a wireless connection, such as Bluetooth connection with a device.

At step 303, the set top box sends the information via the non-landline telephone connection to the service provider. In one embodiment, as shown in FIG. 1, the set top box 123c may use a LAN, such as the network 122, and the external network 105 to send information to the satellite service provider 104d. In another embodiment, such as shown in FIG. 2, the cellular network 160 may be used to send information to the satellite service provider 104d. Also, a wireless connection, such as a Bluetooth connection, may be established between the set top box 123c and the mobile telephone 150, so the set top box 123c may use the mobile telephone 150 to call the satellite service provider 104d. In another embodiment, the set top box 123c may include its own cellular transceiver for making calls, such as calling the satellite service provider 104d. Also, a Bluetooth or other type of wireless connection may be used by the set top box 123c to communicate with any device that is operable to communicate with the satellite service provider 104d via an external network.

At step 304, a service is received via the set top box in response to sending the information. The service is provided via a medium different than the non-landline connection. For example, the non-landline connection may be provided via a LAN and HFC network or via a peer-to-peer wireless connection (e.g., Bluetooth) and a cellular network. The service may be provided via satellite. For example, content for a premium service is received via satellite at the set top box 123c.

It should be noted that there may be many alternatives or variations to the method 300. At step 302, a non-landline telephone connection between the set top box and the service provider is established, and at step 303 the non-landline connection may be used to send service-related information. In some instances, there may be several connections initially established, and one of the connections is used to send the service-related information to the service provider. For example, if the set top box has an active telephone landline connection and an active network connection, the user may set a preference to use the telephone landline connection if available bandwidth for the LAN is below a threshold, or the user may set a preference to use the network connection if the telephone landline connection is busy. If a Bluetooth connection with a cellular phone is established and a network connection is also established, the user may prefer to use the network connection to avoid paying fees for cellular network usage unless the network connection is unavailable.

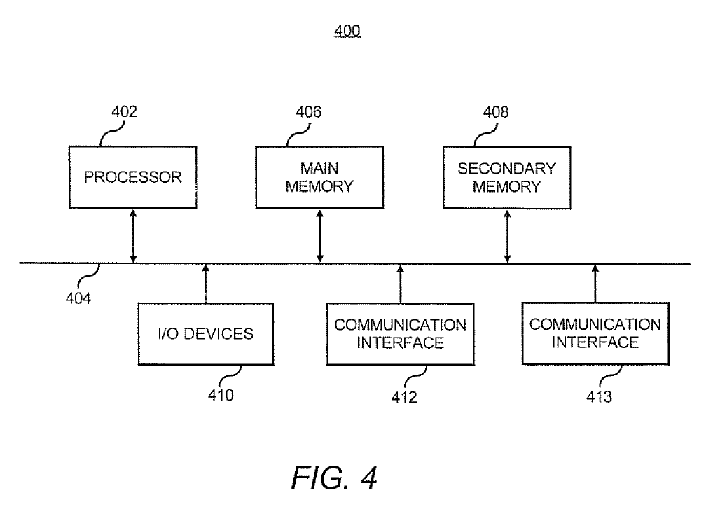

FIG. 4 illustrates a computer system, according to an embodiment. The computer system 400 includes processor 402 providing an execution platform for executing software. Commands and data from the processor 402 are communicated over a communication bus 404. The computer system 400 also includes a main memory 406, such as a Random Access Memory (RAM), where software may reside during runtime, and a secondary memory 408. The secondary memory 408 includes, for example, a hard disk drive and/or a removable storage drive representing a floppy diskette drive, a magnetic tape drive, a compact disk drive, etc., or a nonvolatile memory where a copy of the software is stored. In one example, the secondary memory 408 also includes ROM (read only memory), EPROM (erasable, programmable ROM), EEPROM (electrically erasable, programmable ROM). The computer system 400 includes I/O devices 410. The I/O devices 410 may include a display and/or user interfaces comprising one or more I/O devices 410, such as a keyboard, a mouse, a stylus, remote control, and the like. However, the I/O devices 410 are optional as well as other shown components. A communication interface 412 is provided for communicating with other computer systems. The communications interface 412 may facilitate connection to one or more networks.

In one embodiment, the computer system 400 represents a platform for one of the satellite set top boxes 123c and 123d described above. The computer system 400 may include two interfaces 412 and 413. One interface is a non-landline telephone interface (e.g., Bluetooth, cellular, LAN interface) and the other interface is a satellite interface for receiving content from the service provider. One or more of the steps of the method 300 and other steps described herein may be implemented as software stored on a computer readable medium, such as the memory 406 and/or 408, and executed on the set top box, for example, by the processor 402. The set top box may include many other circuits and software that are not shown but are well known in the art.

The steps are operable to be embodied by a computer program, which can exist in a variety of forms both active and inactive. For example, they exist as software program(s) comprised of program instructions in source code, object code, executable code or other formats for performing some of the steps. The codes described above may be embodied on a computer readable medium, which include storage devices and signals, in compressed or uncompressed form. Examples of suitable computer readable storage devices include conventional computer system RAM (random access memory), ROM (read only memory), EPROM (erasable, programmable ROM), EEPROM (electrically erasable, programmable ROM), and magnetic or optical disks or tapes. Examples of computer readable signals, whether modulated using a carrier or not, are signals that a computer system running the computer program may be configured to access, including signals downloaded through the Internet or other networks. Concrete examples of the foregoing include distribution of the programs on a CD ROM or via Internet download. In a sense, the Internet itself, as an abstract entity, is a computer readable medium. The same is true of computer networks in general. It is therefore to be understood that those functions enumerated below may be performed by any electronic device capable of executing the above-described functions.

While the embodiments have been described with reference to examples, those skilled in the art will be able to make various modifications to the described embodiments without departing from the true spirit and scope. The terms and descriptions used herein are set forth by way of illustration only and are not meant as limitations. In particular, although the methods have been described by examples, steps of the methods may be performed in different orders than illustrated or simultaneously. Those skilled in the art will recognize that these and other variations are possible within the spirit and scope as defined in the following claims and their equivalents.

What is claimed is:

1. A method of providing conditional access for a service, the method comprising:
detecting an event requiring transmission of information to a service provider from a set top box;
establishing a non-landline telephone connection between the set top box and the service provider;
sending the information via the non-landline telephone connection to the service provider; and
receiving a service via the set top box in response to sending the information, wherein the service is provided via a medium different than the non-landline connection.

2. The method of claim 1, wherein establishing a non-landline telephone connection between the set top box and the service provider comprises:
determining a user preference for a type of connection to establish between the set top box and the service provider; and
selecting the non-landline telephone connection based on the user preference.

3. The method of claim 2, wherein the user preference specifies a condition for selecting the non-landline connection and selecting the non-landline telephone connection comprises:
determining whether the condition exists; and
selecting the non-landline telephone connection if the condition exists.

4. The method of claim 3, wherein the condition comprises determining whether the landline telephone connection is unavailable.

5. The method of claim 3, wherein a plurality of different types of non-land line connections between the set top box and the service provider are available and selecting the non-landline telephone connection comprises:
selecting one of the non-land line connections based on cost.

6. The method of claim 1, wherein the non-landline telephone connection comprises a local area network connection at a customer premises where the set top box is located.

7. The method of claim 6, wherein the non-landline telephone connection further comprises a connection in an Internet Protocol network external to the customer premises.

8. The method of claim 1, wherein the non-landline telephone connection comprises a connection in a cellular network, and establishing a non-landline telephone connection between the set top box and the service provider comprises:
establishing a connection between the set top box and the service provider via the cellular network.

9. The method of claim 1, wherein the non-landline telephone connection comprises a Bluetooth connection between the set top box and another device that is operable to communicate with the service provider.

10. The method of claim 1, wherein the service is a service providing content via satellite, and the set top box is a satellite set top box used to receive the service.

11. The method of claim 10, wherein detecting an event requiring transmission of information to a service provider from a set top box comprises:
receiving a request for a premium service from a user; and
sending the information comprises sending the request via the non-landline telephone connection to the service provider.

12. A satellite set top box operable to provide a service from a satellite service provider at a customer premises, the satellite set top box comprising:
a non-landline telephone interface configured to send information to the satellite service provider;
a satellite interface configured to receive content for the service;
a processor establishing a connection between the set top box and the satellite service provider via the non-landline telephone interface and sending a service-related request via the non-landline telephone interface to the satellite service provider; and
the set top box receives content for the service the via the satellite interface in response to sending the service-related request.

13. The satellite set top box of claim 12, wherein the connection comprises a connection in a local area network.

14. The satellite set top box of claim 12, wherein the connection comprises a connection in a cellular network.

15. The satellite set top box of claim 12, wherein the connection comprises a Bluetooth connection to a device that is operable to communicate with the satellite service provider via an external network.

16. The satellite set top box of claim 12, wherein the processor is configured to select the non-landline telephone interface from a plurality of non-satellite interfaces to send the service-related request based on a user preference.

17. The satellite set top box of claim 12, wherein the processor is configured to select from a plurality of non-landline telephone interfaces at the set top box to send the service-related request.

18. A computer readable medium on which is embedded a computer program, the computer program implementing a method of providing conditional access for a service, the method comprising:
detecting an event requiring transmission of information to a service provider from a set top box;
establishing a non-landline telephone connection between the set top box and the service provider;
sending the information via the non-landline telephone connection to the service provider; and
receiving a service via the set top box in response to sending the information, wherein the service is provided via a medium different than the non-landline connection.

19. The computer readable medium of claim 18, wherein the service is a service providing content via satellite, and the set top box is a satellite set top box used to receive the service.

20. The computer readable medium of claim 18, wherein the non-landline telephone connection comprises one of a local area network connection and a Bluetooth connection.
